(19) United States
(12) Patent Application Publication
(10) Pub. No.: US 2008/0022877 A1
(43) Pub. Date: Jan. 31, 2008

(54) COUPLING SYSTEM AND METHOD FOR A PRINTING PRESS

(75) Inventors: Martin Gail, Dasing (DE); Markus Goeppel, Burgau (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/829,728

(22) Filed: Jul. 27, 2007

(30) Foreign Application Priority Data
Jul. 29, 2006 (DE) 20 2006 011 613.3

(51) Int. Cl. B41L 15/14

(52) U.S. Cl. 101/480

(57) ABSTRACT

A printing press coupling system and method for connecting supply lines to a printing press module, specifically to a printing couple or a dampening unit, of a printing press, is disclosed. The coupling system includes a coupling element on a printing press side and a coupling element on a supply line side, where the coupling element on the printing press side and the coupling element on the supply line side comprise all interfaces for centrally connecting all fluid supply lines and/or all electrical supply lines so that all fluid supply lines and/or all electrical supply lines are connectable jointly to the printing press module.

This application claims the priority of German Patent Document No. 20 2006 011 613.3, filed Jul. 29, 2006, the disclosure of which is expressly incorporated by reference herein.

### BACKGROUND AND SUMMARY OF THE INVENTION

The invention relates to a coupling system and method for a printing press to connect supply lines to a printing press module, specifically to an inking couple or a dampening system of a printing press.

Printing presses have several printing press modules, such as inking couples or dampening systems, which have to be supplied on the one hand with media required for printing and with electrical signals. An inking couple for a printing press has to be provided with both ink and coolant for printing and, if necessary, with cleaning agent. Specifically, a supply voltage has to be provided as electrical signals to an inking couple and control signals for actuators of the inking couple.

Printing press modules known from practice have a plurality of interfaces to connect fluid supply lines and electrical supply lines to the printing press module. Each fluid supply line and each electrical supply line can be connected by way of a separate interface to the printing press module, when the interfaces are located dispersed across the printing press module. Connecting the supply lines separately, or specifically individually, to a printing press module requires a great expenditure of time and is furthermore liable to error, since supply lines, for example, can be connected across an incorrect interface to a printing press module. Inlet lines and return lines can be switched when connecting fluid supply lines.

In accordance with the invention, the printing press coupling system comprises a coupling element on the printing press module side and a coupling element on the supply line side, where the coupling element on the printing press module side and the coupling element on the supply line side comprise all interfaces to centrally connect all fluid supply lines and/or all electrical supply lines so that all fluid supply lines and/or all electrical supply lines can be connected in common to the printing press module.

Within the meaning of the present invention, it is provided to provide a central printing press coupling system to connect all fluid supply lines and/or to connect all electrical supply lines which comprise a coupling element on the printing press module side and a coupling element on the supply line side. The coupling element on the printing press module side and the coupling element on the supply line side comprise all interfaces for the central, or common, connection of all fluid supply lines and/or all electrical supply lines to the printing press module. The expenditure of time required for connecting and disconnecting supply lines to a printing press module can thereby be reduced. Furthermore, the risk that the supply lines are connected to a wrong interface when they are being connected is reduced. Further, a central printing press coupling system requires less space so that a more compact design for printing press modules can be implemented. Finally, accessibility to the interfaces is improved so that inspection of the interfaces is easier.

Preferred further developments of the invention become clear from the subsequent description. Embodiments of the invention, without being restricted thereto, are explained in more detail with reference to the drawings.

### BRIEF DESCRIPTION OF THE DRAWINGS

FIG. 1 shows a printing press coupling system in accordance with a first embodiment of the invention for centrally connecting all fluid supply lines to a printing press module when connected;

FIG. 2 shows the printing press coupling system from FIG. 1 when disconnected;

FIG. 3 shows a printing press coupling system from a second embodiment of the invention for centrally connecting all electrical supply lines to a printing press module when connected; and

FIG. 4 shows the printing press coupling system from FIG. 3 when disconnected.

### DETAILED DESCRIPTION OF THE DRAWINGS

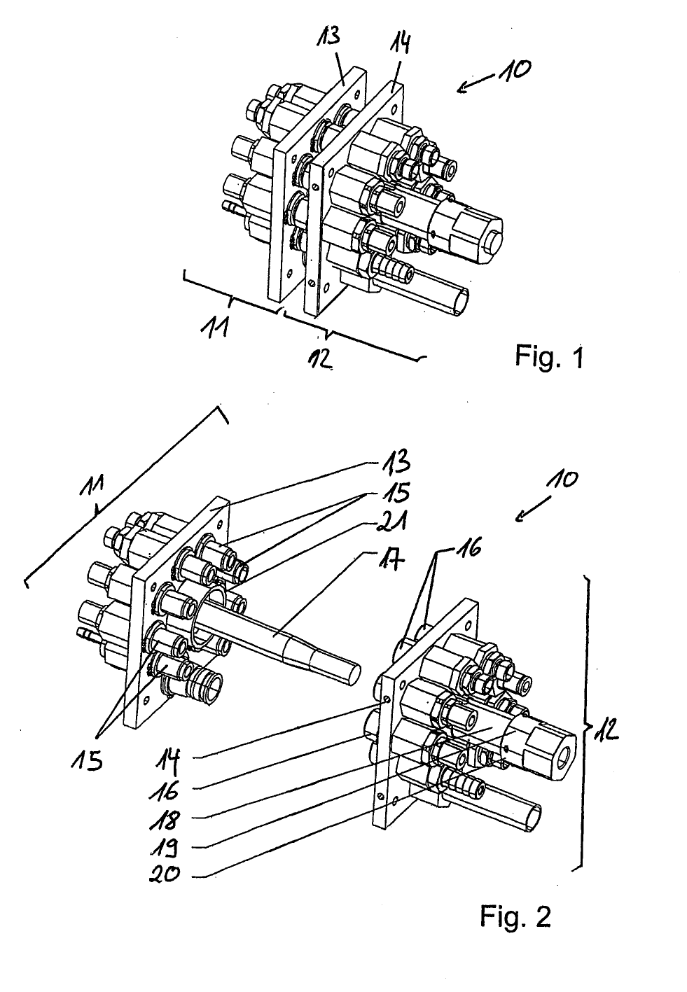

The present invention relates to a printing press coupling system and method for connecting supply lines to a printing press module of a printing press, specifically to a printing couple, a dampening system or an imaging unit of a printing press. The printing press coupling system in accordance with the invention is configured such that all fluid supply lines and/or all electrical supply lines which have to be connected to the printing press module can be connected centrally and thus in common to the printing press module. This will be described in greater detail hereinafter with reference to FIGS. 1 to 4 using the example of two embodiments.

FIGS. 1 and 2 show a first embodiment of a printing press coupling system 10 in accordance with an embodiment of the invention. The printing press coupling system 10 from FIGS. 1 and 2 comprises only interfaces for connecting all fluid supply lines centrally to a printing press module.

The printing press coupling system in accordance with the invention 10 from FIGS. 1 and 2 has a coupling element on the printing press module side, specifically a fixed coupling system 11 and a coupling element 12 on the supply line side, which, in contrast to the fixed coupling element 11, is moveable. The coupling element 11 on the printing press module side as well as the coupling element 12 on the supply line side both possess, in accordance with FIGS. 1 and 2, a foundation plate, or base plate, 13, 14 where the base plates 13, 14 of the coupling elements 11, 12 comprise all interfaces for centrally connecting all fluid supply lines. So the interfaces for connecting the fluid supply lines are formed of sockets and plugs, where in the embodiment from FIGS. 1 and 2 the base plate 13 of the coupling element 11 on the printing press module side comprises the plugs 15 and the base plate 14 of the coupling element 12 on the supply line side comprises the sockets 16 into which the plugs 15 of the printing press module side coupling element 11 can be inserted when connecting the supply lines to a printing press module. Through a specified distribution, or arrangement, of the plugs 15 and sockets 16 on the base plate 13 or 14 of the particular coupling element 11 or 12, a coding is predetermined which makes it impossible to connect a supply line to a printing press module via a wrong interface.

To make it easier to connect the two coupling elements 11 and 12, an extension 17 is assigned to the coupling element on the printing press module side which can be inserted into a receptacle 18 on the coupling element 12 on the supply line side when connecting the two coupling elements 11 and 12.

The extension 17 of the coupling element 11 on the printing press module side and the receptacle 18 of the coupling element 12 on the supply line side form elements of a centering device to make it easier to connect the two coupling elements 11 and 12 and to define the relative positions of the base plates 13 and 14 of the two coupling elements 11 and 12. Via a nut 19 assigned to the receptacle 18 with a locking collar 20, the two coupling elements 11 and 12 can be secured relative to one another in the connected position.

To connect the two coupling elements 11 and 12 of the printing press coupling system 10 from FIGS. 1 and 2, the receptacle 18 of the coupling element 12 on the supply line side is therefore slid over the extension 17 of the coupling element 11 on the printing press side, when with the aid of the nut 19 the coupling element 12 on the supply line side can be moved towards the coupling element 11 on the printing press module side, until the element abuts against a stop 21 configured as a spacer ring. The stop 21 ensures that the interfaces formed by the plugs 15 and sockets 16 are positioned to operate correctly at the proper distance from each other to ensure uninterrupted passage of fluids across the interfaces.

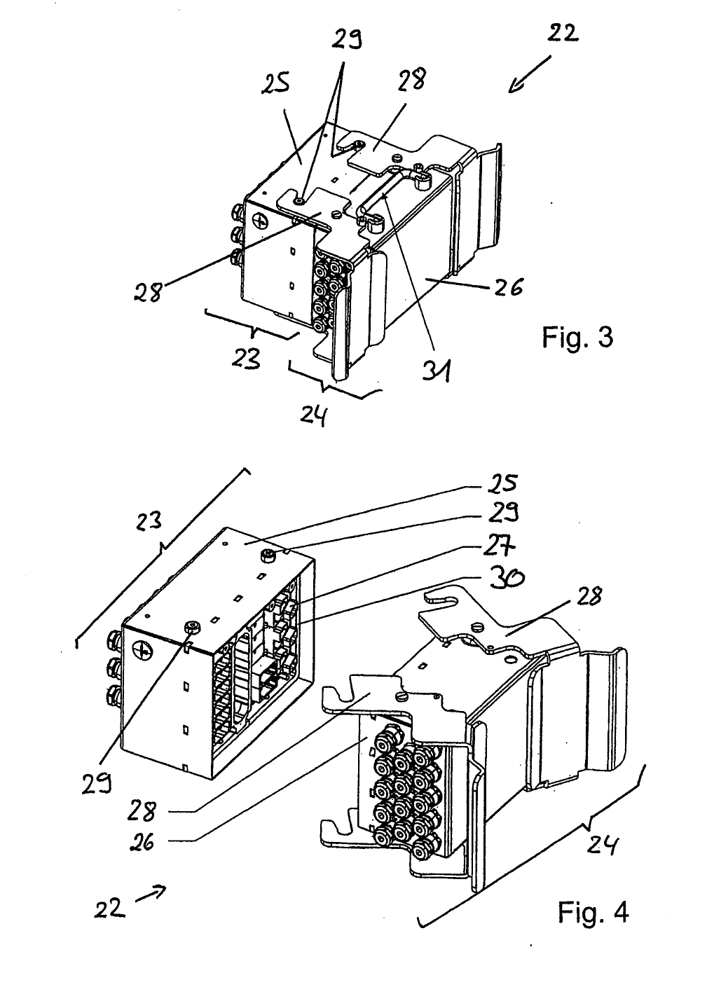

FIGS. 3 and 4 show a further embodiment of a printing press coupling system 22 in accordance with the invention, where the printing press coupling system 22 from FIGS. 3 and 4 comprises all the interfaces for connecting all the electrical supply lines to a printing press module. The printing press coupling system 22 from FIGS. 3 and 4 is in-turn formed by a coupling element 23 preferably fixed on the printing press side and a coupling element 24 on the supply line side which, in contrast to the fixed coupling element 23, can be moved.

In the embodiment from FIGS. 3 and 4, both the coupling element 23 on the printing press module side and the coupling element 24 on the supply line side have a housing 25 or 26, which form the interfaces to the central connection of the supply lines to the printing press module. These interfaces are in-turn formed by plugs and sockets, with only plugs 27 for the coupling element 23 on the printing press module side being shown in FIGS. 3 and 4 which can be inserted into correspondingly shaped sockets in the coupling element 24 on the supply line side. The arrangement of the interface elements, specifically of the plugs and sockets, in the housings 25 and 26 defines a coding which defines the connection of the two housings 25 and 26 so that connecting a supply line to the printing press module incorrectly through a wrong interface can be prevented.

Connecting the two coupling elements 23 and 24 is assisted by clamping plates 28 which in the embodiment shown from FIGS. 3 and 4 are assigned to the coupling element 24 on the supply line side and cooperate with the projections 29 assigned to the coupling element 23 on the printing press module side.

To connect the two coupling elements, the coupling element 24 on the supply line side is pushed onto the coupling element 23 on the printing press side until mechanical resistance becomes too great, where this mechanical resistance is overcome with the aid of the clamping plates 28 when the projections 29 are introduced into correspondingly contoured recesses in the clamping plates 28 and the clamping plates 28, which are carried rotatably on the housing 26 of the coupling element 24 on the supply line side, are pivoted into the positions shown in FIG. 3. In this case, all the plugs on the coupling element 23 on the printing press module side are securely inserted into the corresponding sockets of the coupling element 24 on the supply line side.

To protect against contamination, a seal is assigned in accordance with FIG. 4 to the coupling element 23 on the printing press module side which, with the two coupling elements 23 and 24 in the connected position, seals the elements to each other and to the outside.

In accordance with FIG. 3, a handle 31 is additionally assigned to the coupling element 24 on the supply line side, by which the coupling system 22 on the printing press side can be held to prevent grasping the coupling system by the projecting sections of the clamping plates 28 and thereby possibly causing unintentional disconnection of the two coupling elements 23 and 24.

In the embodiment from FIGS. 1 and 2, the printing press coupling element 10 in accordance with the invention comprises only interfaces to connect all fluid supply lines centrally to a printing press module. In the embodiment from FIGS. 3 and 4, on the other hand, the printing press coupling system 22 in accordance with the invention comprises only interfaces to connect all electrical supply lines jointly, or centrally, to a printing press module. It is also possible to prepare a printing press coupling system which combines the two functions which in this way comprises the interfaces for connecting all fluid supply lines as well as the interfaces to connect all electric supply lines to a printing press module.

### Reference Numeral List

10 Printing press coupling system

11 Coupling element on the printing press side

12 Coupling element on the supply line side

13 Base plate

14 Base plate

15 Plug

16 Socket

17 Extension

18 Receptacle

19 Nut

20 Locking collar

21 Stop

22 Printing press coupling system

23 Coupling element on the printing press side

24 Coupling element on the supply line side

25 Housing

26 Housing

27 Plug

28 Clamping plate

29 Projection

30 Seal

31 Handle

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing press coupling system for connecting supply lines to a printing press module, specifically to a printing couple or a dampening unit, of a printing press, comprising a coupling element on a printing press side and a coupling element on a supply line side, wherein the coupling element on the printing press side and the coupling element on the supply line side comprise all interfaces for centrally connecting all fluid supply lines and/or all electrical supply lines so that all fluid supply lines and/or all electrical supply lines are connectable jointly to the printing press module.

2. The printing press coupling system according to claim 1, wherein the coupling element on the printing press side and the coupling element on the supply line side comprise all interfaces for a common, or central, connection of all fluid supply lines.

3. The printing press coupling system according to claim 2, wherein the coupling element on the printing press side and the coupling element on the supply line side each include a base plate, where the base plates carry all sockets and/or plugs for the interfaces to centrally connect all fluid supply lines and where the base plates further include elements for a centering device to specify a relative position of the base plates, and thus of the coupling elements, when connected.

4. The printing press coupling system according to claim 1, wherein the coupling element on the printing press side and the coupling element on the supply line side comprise interfaces for centrally connecting supply lines for ink and/or dampening solution and/or detergent and/or coolant and/or compressed air.

5. The printing press coupling system according to claim 1, wherein the coupling element on the printing press side and the coupling element on the supply line side comprise all interfaces for a common, or central, connection of all electrical supply lines.

6. The printing press coupling system according to claim 5, wherein the coupling element on the printing press side and the coupling element on the supply line side each include a housing, wherein the housings carry all sockets and/or plugs for the interfaces to centrally connect all electrical supply lines and where the housings further include elements for a locating unit to define a relative position of the housings, and thus of the coupling elements, when connected.

7. The printing press coupling system according to claim 1, wherein the coupling element on the printing press side and the coupling element on the supply line side include elements for centrally connecting all fluid supply lines and interfaces for centrally connecting all electrical supply lines.

8. A printing press coupling system, comprising:
a first coupling element disposed on a printing press side of a printing press; and
a second coupling element disposed on a supply line side of the printing press;
wherein the first coupling element is coupled to the second coupling element and wherein a supply line of the printing press is connected to the printing press through the first and second coupling elements.

9. The printing press coupling system according to claim 8, wherein the supply line is a fluid supply line.

10. The printing press coupling system according to claim 8, wherein the supply line is an electrical supply line.

11. The printing press coupling system according to claim 8, wherein the first coupling element includes a plug, wherein the second coupling element includes a socket, and wherein the supply line is associated with the plug and socket.

12. The printing press coupling system according to claim 11, wherein the plug and the socket include a like coding.

13. The printing press coupling system according to claim 8, wherein the first coupling element includes a centering extension, wherein the second coupling element includes a receptacle, and wherein the centering extension is received within the receptacle.

14. The printing press coupling system according to claim 8, wherein the first coupling element includes a projection, wherein the second coupling element includes a clamping plate, and wherein the projection is received within the clamping plate.

15. A method for connecting a supply line to a printing press, comprising the steps of:
disposing a first coupling element on a printing press side of the printing press;
disposing a second coupling element on a supply line side of the printing press;
coupling the first coupling element to the second coupling element; and
connecting a supply line to the printing press through the first and second coupling elements.

16. The method according to claim 15, wherein the supply line is a fluid supply line.

17. The method according to claim 15, wherein the supply line is an electrical supply line.

18. The method according to claim 15, wherein the first coupling element includes a plug, wherein the second coupling element includes a socket, and wherein the supply line is associated with the plug and socket.

19. The method according to claim 18, further comprising the step of similarly coding the plug and the socket.

20. The method according to claim 15, further comprising the step of positioning a centering extension of the first coupling element into a receptacle of the second coupling element.
